(19) United States
(12) Patent Application Publication
(10) Pub. No.: US 2019/0176401 A1
(43) Pub. Date: Jun. 13, 2019

(54) PRODUCTION DEVICE

(71) Applicant: Technische Universität München, München (DE)

(72) Inventors: Stefan FISCHER, Penzberg (DE); Sebastian Tobias PAMMER, München (DE); Stefan LEONHARDT, München (DE); Miriam HAERST, München (DE)

(73) Assignee: Technische Universität München, München (DE)

(21) Appl. No.: 16/324,540

(22) PCT Filed: Aug. 8, 2017
(86) PCT No.: PCT/EP2017/070051

§ 371 Date: Feb. 8, 2019

(30) Foreign Application Priority Data
Aug. 8, 2016 (EP) 16183227.4

(51) Int. Cl. B29C 64/321; B33Y 10/00; B33Y 30/00; B33Y 40/00; B29C 64/205; B29C 64/118

(52) U.S. Cl. CPC B29C 64/321; B33Y 10/00; B29C 64/118; B33Y 40/00; B29C 64/205; B33Y 30/00

(57) ABSTRACT

A production device for layer-by-layer manufacture of a three-dimensional object, comprising a feeding device for feeding in of a starting material, and an application device for melting the starting material and for layer-by-layer shaping of the melted starting material into the object, wherein the feeding device comprises a drying device for drying of the starting material, or a drying device is connected upstream of the feeding device.

### TECHNICAL FIELD

This invention relates to a production device for layer-by-layer manufacture of a three-dimensional object. Furthermore the invention relates to a method for layer-by-layer manufacture of a three-dimensional object.

### BACKGROUND

Layer-by-layer manufacture of three-dimensional objects is known from the state of the art. It is in particular used as a variant of “Rapid Prototyping” to manufacture objects quickly and in any required shapes. A method of this type is in particular Fused Deposition Modeling (or Fused Filament Fabrication). With this method, the object to be produced is built up layer by layer from a meltable plastic. To do so, a starting material is used which is fed to an application device. Inside this application device, also called an extrusion head, the starting material is melted to manufacture a layer of the three-dimensional object. Then the application device and/or a platform carrying the object are displaced by one layer thickness, allowing a new layer to be applied onto the old one.

Thermoplastics that are suitable for use in these production methods are known from the state of the art. These plastics have up to 9% by weight of water, which can cause major problems during processing. For example, excessive water retention in the plastic leads to steam bubbles during processing and/or to foaming. Furthermore there are filling problems, mould release problems, viscosity fluctuations, a spread of process parameters and/or fluctuating throughputs. During further processing of the manufactured three-dimensional objects, problems can occur during galvanization or painting. In other plastic types, the water triggers a chemical reaction during melting of the plastic, which alters the molecular structure. This reaction, called hydrolysis, leads to a reduced molecular weight, with the result that the viscosity of the plastic drops. Not least there are also optical, chemical and/or physical disadvantages when excessively moist plastics are used. Obvious defects are, in particular, striations, cavities, holes and/or bubbles on the surface.

The object underlying the present invention is therefore to provide a production device, which while being easily and cost-effectively producible and mountable, enables a safe and dependable manufacture of three-dimensional objects. Another object of the present invention is to provide an appropriate method.

The Solution of the above problematics is provided by the features of the independent claims. Preferred developments of the present invention become apparent from the sub-claims.

### BRIEF DESCRIPTION OF THE DRAWINGS

FIG. 1 shows a schematic representation of a production device in accordance with a first exemplary embodiment of the invention,

FIG. 2 shows a schematic representation of a production device in accordance with a second exemplary embodiment of the invention,

FIG. 3 shows a schematic representation of a production device in accordance with a third exemplary embodiment of the invention, and

FIG. 4 shows a schematic representation of a production device in accordance with a fourth exemplary embodiment of the invention.

### DESCRIPTION

The problem is thus solved by a production device for layer-by-layer manufacture of a three-dimensional object. This production device comprises a feeding device and an application device. The feeding device is configured for feeding in of a starting material. Particularly advantageously, strand-like starting material can be fed in, such that the feeding device feeds said strand-like starting material to the application device. The application device in turn is used for melting and layer-by-layer shaping of the melted starting material into the three-dimensional object to be manufactured. To do so, the application device is advantageously designed as a nozzle which can put the melted starting material, preferably the melted plastic, into a two-dimensional shape. The application device thus corresponds substantially to a print head, wherein one layer of the three-dimensional object can be manufactured per printing operation. A further layer from the melted starting material can then be applied to the layer thus manufactured. It is furthermore provided that the feeding device comprises a drying device, or a drying device is connected upstream of the feeding device. The drying device is configured for drying of the starting material. The starting material is thus dryable before it reaches the application device. In this way, the melting and the drying steps in particular are separate. When the starting material reaches the application device, it is assured by the drying device that a sufficiently dry starting material is available. To do so, the drying device is in particular equipped to reduce the proportion of absorbed water inside the starting material to a presettable or preset limit value for % by weight. Due to drying of the starting material, the disadvantages described above can thus be avoided, with drying being performed easily and inexpensively. In particular, it can be avoided with the production device in accordance with the invention that pre-dried starting material has to be expensively stored to ensure that the moisture of the starting material does not increase during storage, to permit subsequent use of the pre-dried starting material in a hermetically shielded production device.

The invention furthermore relates to a method for layer-by-layer manufacture of a three-dimensional object. The method comprises the following steps: first a starting material is fed to an application device. The application device is in particular designed as a nozzle and preferably permits melting of the starting material. In a further step, the starting material is thus melted by the application device. Furthermore, the melted starting material is shaped layer by layer into the three-dimensional object to be manufactured. It is provided here that the application device shapes one layer each time, so that a further layer is then applicable onto the previously shaped layer. The starting material is dried during or prior to being fed to the application device. This permits a safe and dependable manufacture of three-dimensional objects, since the step of drying always ensures that only starting material which has low moisture is used by the application device during melting and layer-by-layer shaping. Low moisture must be understood as the water content being below a presettable or preset limit value for % by weight. Since drying is integrated into feeding, the production process for the three-dimensional objects is also easy and inexpensive and permits a high throughput. When compared with the state of the art in particular, drying requires no additional process time that would slow down the entire production process.

Advantageously, the drying device comprises a heating device and/or a microwave generator and/or a desiccant and/or an osmotic gradient and/or a vacuum. The starting material can be heated up using the heating device. Due to the temperature increase, the moisture in the starting material evaporates, whereby the starting material can be dried. Using the desiccant and/or the osmotic gradient and/or the vacuum results in drying without heating up the starting material.

The heating device preferably comprises an infrared heater and/or an electric heating element and/or a microwave generator. In particular, it is provided that heat transfer onto the starting material takes place while the starting material is being passed through the heating device. Drying by the heating device is thus a continuous process. The infrared heater and/or the electric heating element and/or the microwave generator thus have a length along the starting material that permits a sufficient heat supply to the starting material passed through the heating device. In particular, the heating device must have a length along the starting material such that the previously described maximum limit value for % by weight of water in the starting material can be attained.

According to a preferred exemplary embodiment, the capacity of the drying device, preferably the heating capacity of the heating device, is adjustable, in particular depending on the presettable or preset limit value for % by weight of the water content. The production device particularly preferably comprises a control or regulating device which is configured to adjust the capacity of the drying device, in particular the heating capacity of the heating device.

In a further exemplary embodiment, at least one first measuring device upstream of the drying device is additionally provided and is configured to determine the water content in the starting material before it is fed to the drying device and/or at the inlet of the drying device. The first measuring device can in particular determine the water content of the starting material by means of microwave resonance and/or capacitively and/or by ohmic resistance and/or by infrared reflection. The control or regulating device is preferably configured to control the capacity of the drying device, in particular the heating capacity of the heating device, depending on the water content inside the starting material determined by means of the first measuring device and on the presettable or preset limit value for % by weight of the water content.

Alternatively or additionally, at least one second measuring device may be provided which is configured and arranged to determine the water content inside the starting material during drying of the starting material in the drying device and/or at the outlet of the drying device, to verify that the starting material at the outlet of the drying device has a water content which does not exceed the presettable or preset limit value for % by weight. The control or regulating device may preferably raise or lower the capacity of the drying device based on the water content determined by means of the at least one second measuring device.

The starting material is heatable by the heating device to a temperature below its melting temperature. This prevents the starting material from already melting in the feeding device. Melting thus takes place only in the application device. Before reaching the application device, the starting material has a firm state. The heating device is thus only intended for drying of the starting material.

The drying device advantageously comprises a fan. The fan is particularly advantageously combinable with the previously described heating device. In this way, drying can be optimized. In particular an ambient air around the starting material can be moved and/or dissipated, thereby improving a drying capacity by absorbing water from the starting material through the ambient air and/or by dissipating the moisture.

The drying device preferably has a dry air supply and a moist air discharge. Using the dry air supply, air may be fed in to dry the starting material. Using the moist air discharge, the moist air may be discharged after drying of the starting material. The moisture can thus be removed from the starting material.

The drying device comprises preferably a substrate for moisture absorption. Moisture absorption is in particular usable for air dehumidification. The moisture removed from the starting material by the drying device can thus be stored in the substrate. This prevents humidification of an environment of the production device. The substrate for moisture absorption and/or air dehumidification is advantageously exchangeable and can therefore be replaced once it has absorbed a predefined quantity of moisture.

The feeding device preferably has a first section and a second section. Undried starting material can be passed to the drying device via the first section. The dried starting material can be passed from the drying device to the application device via the second section. In particular, the first section and/or the second section enclose(s) the starting material completely. This ensures in particular that the starting material cannot again absorb moisture while being fed from the drying device to the application device along the second section. Alternatively, the first section and the second section enclose the starting material only partially. To prevent any absorption of moisture, it is then preferably provided that the starting material only comes into contact with dried air or is passed through a vacuum.

Particularly advantageously, the starting material can be taken from a supply roll via the first section. These supply rolls are known from the state of the art and serve to store the starting material safely and dependably. By the use of the drying device inside the feeding device, it is thus not necessary that these supply rolls already have dried starting material, thereby greatly simplifying storage and handling of the supply rolls.

Furthermore, it is advantageously provided that the feeding device comprises a pipe element. The starting material can be passed inside the pipe element. The pipe element can advantageously be designed flexible and hence as a hose element. Inside the pipe element, the starting material is preferably narrowly guided, so that a pressure necessary for shaping by the application device can be applied to the starting material. Alternatively, the pressure necessary for shaping is applied solely by the application device to the starting material. At the same time, the pipe element shields the starting material from an environment, preventing absorption of moisture from the environment. In a first advantageous alternative, the feeding device additionally comprises the previously described first section and second section. An initial pipe element is thus provided that passes the starting material to the drying device, while an end pipe element passes the starting material from the drying device to the application device. In a second alternative, it is preferably provided that the drying device is integrated into the pipe element, so that the drying device extends at least over a partial area of the pipe element. The starting material is thus dryable over this partial area of the pipe element.

The feeding device is particularly advantageously configured to feed a first starting material and a second starting material to the application device. The drying device is configured here for drying both the first starting material and the second starting material. The first starting material is advantageously a production material from which the three-dimensional object is to be produced. The second starting material is in particular an auxiliary material used for making support devices. This auxiliary material can be removed again after production of the three-dimensional object. By using the same drying device, production of the three-dimensional object can be implemented very easily and inexpensively, wherein an auxiliary material too can be used to make a supporting structure during production.

The feeding device of the production device preferably comprises a discharge device. The discharge device is configured to emit ionizing radiation. The discharge device may for example be an ion air gun. The starting material is electrostatically discharged by the ionizing radiation. The electrostatic discharge prevents adhesion in particular of dust particles or impurities on the surface of the starting material. Additionally, a plasma source may be used to pretreat and/or sterilize the surface of the starting material.

Furthermore it is preferably provided that the feeding device of the production device comprises a measuring device. By means of the measuring device, the starting material can be checked for a required cross-sectional geometry. In particular the diameter, the ovality and/or the roundness are important parameters of the starting material. If the starting material does not meet the required properties, the feed of the starting material via the feeding device can be stopped to prevent wastage of starting material for expected misprints and hence rejects.

Particularly advantageously, said measuring device makes use of an optical measuring method. Light radiation is emitted, preferably by a light-emitting diode, which is detected at a receiver. The starting material is located in the beam path of the emitted radiation. The evaluation of the detected radiation allows a conclusion to be drawn about the diameter of the starting material. By measurement of a roundness and/or ovality, a feed rate of the feeding device can be regulated, taking into account the position of the shorter semi-axis relative to the longer one. The feeding device thus mostly has friction wheels for driving the starting material. Based on the position of the shorter semi-axis relative to the longer one, the speed of the friction wheels can be regulated. It is preferably provided that the position of the semi-axes before the starting material enters the area of the friction wheel(s) is influenced such that the longer or shorter semi-axis is always contacting the friction wheel(s). This can be advantageously achieved using guide panels pressed onto the side faces of the oval starting material. This allows the starting material to be aligned.

In a further preferred embodiment, the feeding device of the production device comprises a testing unit based on visual checking and/or magnetic fields and/or electric fields and/or electromagnetic fields and/or ultrasound. A visual testing unit serves in particular to determine a colour and/or a geometry of the starting material. A testing unit based on magnetic fields and/or electric fields and/or electromagnetic fields and/or ultrasound serves in particular to detect impurities and/or filament defects. A testing unit of this type may advantageously be a camera and/or Hall sensors and/or an infrared sensor. With this type of testing, foreign bodies and/or impurities and/or filament defects can be detected. Filament defects are in particular cavities or differing filler contents. The surface of the starting material may also be checked for impurities and/or surface quality. Accordingly, a production operation can thus be aborted if the starting material does not have the required properties. Beside the geometry and/or the state of the starting material, the colour is relevant, too. The colour of the starting material is therefore preferably determined by a visual testing unit. Based on the colour, effects of the filler content and/or of crystallinity can be detected. Finally, damage to the polymer structure of the starting material can also be detected.

The feeding device of the production device is advantageously equipped with a thermometer unit. The thermometer unit is used for measuring a temperature of the starting material. In this way, it can be prevented that a too high surface temperature of the starting material already results in an unwanted partial or full melting of the starting material. If the surface of the starting material has a too high temperature, counter-measures can be advantageously initiated to prevent any (premature) partial or full melting of the starting material.

Advantageously, the feeding device of the production device has a surface treatment unit. As previously described, the feeding device advantageously comprises friction wheels used for driving the starting material forward. To increase friction between the friction wheels and the starting material, the surface of the starting material is advantageously modified by means of the surface treatment unit. The surface of the starting material may in this way be altered and/or coated in particular using a radiation source or a particle beam source. The surface of the starting material may be roughened using micro-machining processes or shaping press processes. Also, the surface treatment unit may comprise a spray source for applying dispersed adhesion-promoting substances onto the surface of the starting material, in particular by spraying.

The feeding device preferably has a hardness measuring device for determining a hardness of the starting material. Using the hardness measuring device, damage to the polymer structure of the starting material can be detected easily and inexpensively. This damage can occur in particular due to UV radiation or other ageing effects during storage of the starting material. This can have effects on the mechanical properties of the starting materials, and hence of the three-dimensional objects made from the starting materials. Besides the previously described visual detection of such damage, it is possible by means of the hardness measuring device to detect damage to the polymer structure also based on the hardness of the starting material. The Shore hardness is checked in particular to detect damage to the polymer structure of the starting material.

Further details, advantages and characteristics of the present invention can be inferred from the following description of exemplary embodiments in light of the accompanying drawing.

FIG. 1 schematically shows a production device 1 in accordance with a first exemplary embodiment of the invention. The production device 1 comprises a feeding device 2 and an application device 3. A starting material from a supply roll 7 can be fed to the application device 3 via the feeding device 2. The application device 3 serves to melt the starting material and to shape a layer from the starting material. As soon as the layer is shaped, a further layer is applied onto the previously completed layer. In this way, a three-dimensional object can be manufactured layer by layer from the starting material. The feeding device 2 comprises a first section 5, a second section 6, and a drying device 4. Via the first section 5, the starting material can be taken from the supply roll 7 and fed to the drying device 4. Via the second section 6, the starting material can be passed from the drying device 4 to the application device 3.

The drying device 4 comprises a heating device 8 and a fan 9. The heating device 8 is in particular an electric heating element and serves to heat the starting material to a temperature below its melting temperature. The starting material is therefore not partly or fully melted, but simultaneously the water content inside the starting material is reduced by the supplied heat. In this way, the starting material can be dried by the drying device 4. The fan 9 serves in particular to distribute the heat generated by the heating device 8 and in particular also to dissipate moist air generated by drying of the starting material. Instead of the electric heating element or additionally to the electric heating element, the heating device 8 can also comprise an infrared heater and/or a microwave generator and/or desiccant and/or an osmotic gradient and/or a vacuum.

The drying device 4 is thus integrated into the feeding device 2. This permits easy and inexpensive drying of the starting material, wherein no additional process time is needed for drying and the manufacturing process of the three-dimensional objects by the application device 3 is thus not slowed down. At the same time it is assured that the application device 3 uses only material that has low moisture. Low moisture must be understood as a water content of the starting material being below a presettable or preset limit for % by weight. The processing of dried starting material thus avoids the problems described at the beginning.

A heating capacity of the heating device 8 is in particular adjustable. To do so, a control or regulating device 17 is provided, using which the heating device 8 can be controlled. The heating capacity is therefore settable by means of the control or regulating device 17.

The production device 1 furthermore has a first measuring device 15 connected upstream of the drying device 4. The first measuring device is designed to determine the water content inside the starting material at the inlet of the drying device 4. The first measuring device 15 can in particular determine the water content of the starting material by means of microwave resonance and/or capacitively and/or by ohmic resistance and/or by infrared reflection. The control or regulating device 17 is designed to control the heating capacity of the heating device 8 depending on the water content of the starting material and on a presettable or preset limit value for % by weight of the water content.

The production device 1 also has a second measuring device 16. The second measuring device 16 is designed and arranged to determine the water content inside the starting material at the outlet of the drying device 4, to verify that the starting material at the outlet of the drying device 4 has a water content which does not exceed the presettable or preset limit value for % by weight. The control or regulating device can preferably raise or lower the capacity of the drying device based on the water content determined by means of the at least one second measuring device.

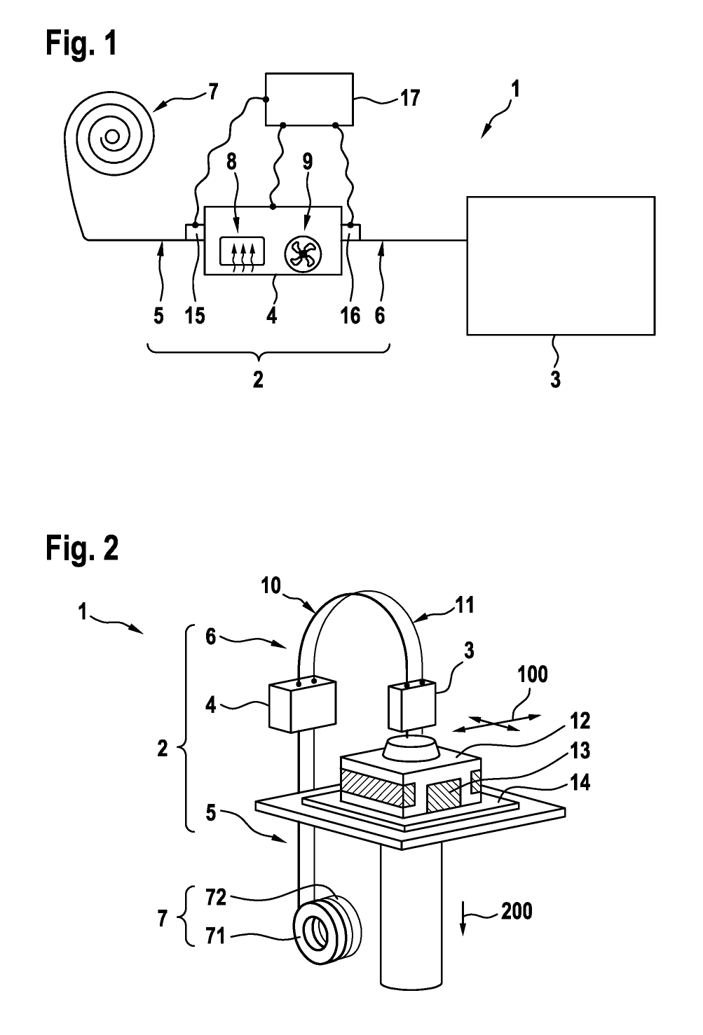

FIG. 2 schematically shows a production device 1 in accordance with a second exemplary embodiment of the invention. Same reference numerals as in FIG. 1 here show identical or similar components as in the first exemplary embodiment.

In contrast to the first embodiment, the production device 1 according to the second exemplary embodiment comprises two starting materials. A first supply roll 71 and a second supply roll 72 are thus provided. In the first supply roll 71 a first starting material is provided, while in the second supply roll 72 a second starting material is provided. The first starting material is a construction material using which a three-dimensional object 12 can be built up layer by layer. The second starting material is a supporting material using which a supporting structure 13 can be manufactured. The supporting structure 13 can be removed again after completion of the three-dimensional object 12.

The feeding device 2 comprises in turn a first section 5, a second section 6 and a drying device 4. The drying device 4 is designed identically to the first exemplary embodiment. The only difference is that both the first starting material and the second starting material are passed through the drying device 4 to dry them.

Both the first section 5 and the second section 6 of the feeding device 2 comprise a first pipe element 10 and a second pipe element 11. The first starting material can be fed to the application device 3 via the first pipe element 10. The second starting material can be fed to the application device 3 via the second pipe element 11. The application device 3 comprises for each starting material its own application nozzle (not shown), using which the melted first starting material or second starting material can be deposited onto a platform 14. To do so, the application device 3 is movable within a plane parallel to the platform 14, as indicated in FIG. 2 by the first movement directions 100. A layer can thus be formed on the platform 14 by movement of the application device 3 along the first movement directions 100. The layer can be formed here both by the first starting material and by the second starting material, so that either a layer of the object 12 to be manufactured or of an additional supporting structure 13 can be applied. Then the platform 14 is moved along a second movement direction 200. The movement along the second movement direction 200 corresponds to a lowering of the platform 14, so that a new layer can be applied to the previously formed layer by the application device 3. In this way, the three-dimensional object 12 can be manufactured layer by layer.

Since the application device 3 is supplied at all times with dried starting material for manufacturing the layers of the three-dimensional object 12, safe and dependable manufacture of the three-dimensional object 12 is possible. The problems mentioned at the beginning are thus avoided.

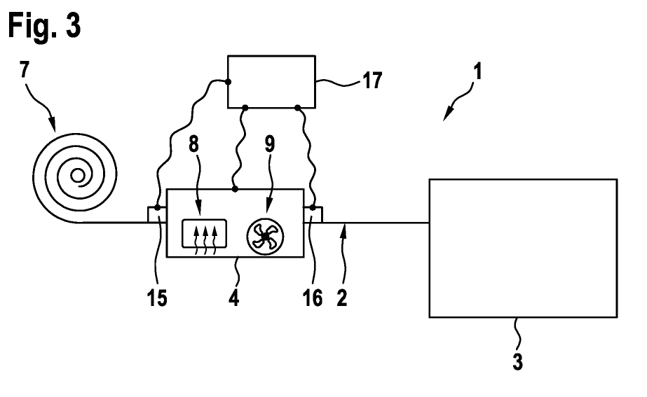

FIG. 3 shows a third exemplary embodiment of the production device 1. Here, the third exemplary embodiment essentially corresponds to the first exemplary embodiment. In the third exemplary embodiment, the drying device 4 is connected upstream of the feeding device 2. The starting material is thus taken from the supply roll 7 and dried by the drying device 4, so that the feeding device 2 takes over the dried starting material from the drying device 4. The mode of operation of the other components is identical to that in the first exemplary embodiment.

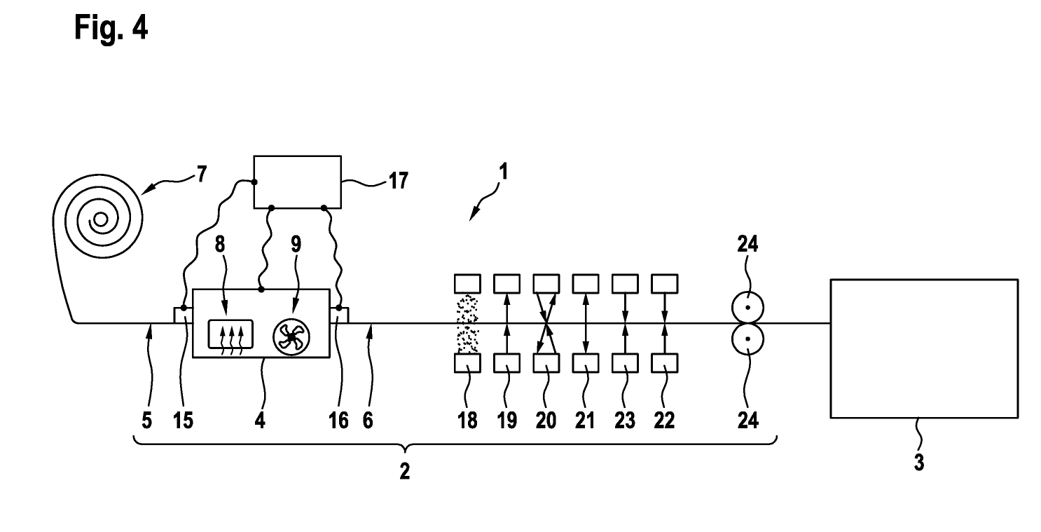

FIG. 4 shows a fourth exemplary embodiment of the production device 1. Here, the fourth exemplary embodiment essentially corresponds to the first exemplary embodiment, with some additional testing devices for testing the starting material being provided. This permits in particular an integrated input control of the quality of the starting material. Properties which the starting material must have to perform printing of the three-dimensional object 12 can thus be predefined. If the starting material does not have one, several or all of the required properties, printing can be aborted.

In addition to the features of the first exemplary embodiment, a discharge device 18, a measuring device 19, a testing unit 20 based on visual checking and/or magnetic fields and/or electrical fields and/or electromagnetic fields and/or ultrasound, a thermometer unit 21, a surface treatment unit 22 and a hardness measuring device 23 are therefore arranged between the application device 3 and the second measuring device 16. FIG. 4 additionally shows friction wheels 24 used to drive the starting material. In particular the starting material is unwound from the supply roll 7 and fed to the application device 3 by the friction wheels 24. It must be noted that the additional checking devices can also be arranged in a sequence differing from that shown in FIG. 4. For example, alternatively all or some of the checking devices can also be arranged between the supply roll 7 and the drying device 4.

The starting material is in the fourth exemplary embodiment fed to the discharge device 18 behind the second measuring device 16. At the discharge device 18, an electrostatic discharge of the starting material is achieved by means of ionizing radiation. In this way, adhesion of dust particles and/or impurities to the surface of the starting material is prevented. Furthermore, a plasma source can be used at the discharge device 18 to pretreat the surface of the starting material, in particular to sterilize it.

Behind the discharge device 18, the starting material is fed to the measuring device 19. The measuring device 19 serves in particular to determine an ovality and/or roundness of the starting material and/or a diameter of the starting material. The measuring device 19 advantageously has a light source and a light receiver. The starting material passes through a beam path from the light source to the light receiver. A conclusion can be drawn about the diameter on the basis of the received light radiation. A degree of roundness and/or ovality of the starting material can also be determined in this way. This is an advantage in particular for controlling the friction wheels 24.

It is thus in particular provided that the speed and hence the feed rate of the friction wheels 24 is regulated taking into account the position of the shorter semi-axis relative to the longer semi-axis of the cross-section of the starting material. Advantageously an alignment of the starting material precedes the feed of the starting material to the friction wheels 24 such that the position of the semi-axes is modified such that the longer and/or shorter semi-axis is always contacting the friction wheels 24. This is advantageously achieved using guide panels (not shown) which exert a force on side faces of the starting material and thereby align the starting material.

Behind the measuring unit 19 the starting material is fed to a testing unit 20, based on visual checking and/or magnetic fields and/or electrical fields and/or electromagnetic fields and/or ultrasound. Based on this testing unit 20, a geometry and/or a colour and/or damage of the starting material can be detected in particular. Based on the geometry check, foreign bodies and/or impurities and/or filament defects can be detected in particular. Filament defects are in particular cavities and/or areas with differing filler content. This can be determined in particular based on data from a camera and/or based on data from Hall sensors. It is also possible to detect preferably a colour of the starting material, since the colour directly reflects influences of the filler content of the starting material and/or of crystallinity. The colour can be determined particularly advantageously by means of infrared sensors.

The polymer structure of the starting material can exhibit damage occurring due to UV radiation or other effects during storage. This damage can be detected by optical and/or mechanical checking of the starting material, since said damage has effects on the optical and/or mechanical properties of the starting materials. It is thus possible using a testing unit 20 to visually check the polymer structure, and damage to said polymer structure can be safely and dependably detected. Particularly advantageously the hardness measuring device 23 is furthermore provided and is used for mechanical checking of the starting material. Since, as already described, damage to the polymer structure is also reflected in mechanical properties of the starting material, such damage to the polymer structure can be detected by determining the hardness, in particular the Shore hardness, of the starting material.

Behind the testing unit 20 the starting material 3 is fed to the thermometer unit 21. A temperature of the starting material can be determined by the thermometer unit 21. In particular a surface temperature of the starting material can be determined, to detect the risk of an unwanted partial or full melting of the starting material. If the surface of the starting material has too high a temperature, counter-measures can be advantageously initiated to prevent any partial or full melting of the starting material. In particular, cooling is possible or a capacity of the drying device 4, in particular of the heating device 8, can be regulated based on the temperature determined by the thermometer unit 21. The drying device 4, in particular the heating device 8, can also be temporarily deactivated.

Finally, it is provided that the starting material is fed to the surface treatment unit 22 before being fed to the friction wheels 24. A surface of the starting material can be processed by the surface treatment unit 22 to increase adhesion between the starting material and the friction wheels 24. With very smooth surfaces, non-slip and/or low-slip conveying in particular is enabled. Particularly advantageously, the surface treatment unit 22 comprises a radiation source or a particle beam source, using which the surface of the starting material can be altered and/or coated. The surface of the starting material can also be roughened using micro-machining processes or shaping press processes. A further possibility provided is that the surface treatment unit has a spray source, using which dispersed adhesion-promoting substances can be deposited onto the surface of the starting material.

The risk of misprints is reduced by these measures additional to those in the first exemplary embodiment. Material defects of the starting material can therefore already be reliably detected before feeding of the starting material to the application device 3. This avoids in particular that the starting material that might have a quality sufficient for other printing is wasted on a misprint and hence on the production of rejects. At the same time it can be achieved by the previously described measures that the starting material is driven safely and dependably by the friction wheels 24. This also results in dependable feeding of the starting material to the application device 3, thereby assuring a uniform print image when producing the three-dimensional object 12 on the platform 4.

Besides the written description of the invention in the foregoing, explicit reference is made to the drawing representation of the invention in FIGS. 1 to 4 for additional disclosure.

### LIST OF REFERENCE NUMERALS

1 Production device
2 Feeding device
3 Application device
4 Drying device
5 First section
6 Second section
7 Supply roll
8 Heating device
9 Fan
10 First pipe element
11 Second pipe element
12 Three-dimensional object
13 Supporting structure
14 Platform
15 First measuring device
16 Second measuring device
17 Control or regulating device
18 Discharge device
19 Measuring device
20 Testing unit based on visual checking and/or magnetic fields and/or electrical fields and/or electromagnetic fields and/or ultrasound
21 Thermometer unit
22 Surface treatment unit
23 Hardness measuring device
24 Friction wheels
71 First supply roll
72 Second supply roll
100 First movement directions
200 Second movement direction

1-21. (canceled)

22. A production device for layer-by-layer manufacture of a three-dimensional object, comprising
a feeding device for feeding in of a starting material; and
an application device for melting the starting material and for layer-by-layer shaping of the melted starting material into the object;
wherein the feeding device comprises a drying device for drying of the starting material, or a drying device is connected upstream of the feeding device; and
wherein the feeding device further comprises one or more of:
a discharge device, by means of which the starting material is electrostatically dischargeable;
a measuring device, by means of which the cross-sectional geometries of the starting material and/or a diameter of the starting material and/or an ovality of the starting material and/or a roundness of the starting material can be determined;
a testing unit based on visual checking and/or magnetic fields and/or electric fields and/or electromagnetic fields and/or ultrasound, for detecting foreign bodies and/or impurities and/or filament defects and/or a color and/or damage to a polymer structure of the starting material;
a hardness measuring device, by means of which a hardness of the starting material can be determined; and
a surface treatment unit, by means of which the surface of the starting material can be modified and/or coated.

23. The production device of claim 22, wherein the drying device comprises one or more of a heating device, a microwave generator, a desiccant, an osmotic gradient, and a vacuum.

24. The production device of claim 22, wherein a drying capacity of the drying device is adjustable by means of a control or regulating device.

25. The production device of claim 23, wherein the drying device comprises a heating device, and the heating device comprises an infrared heater and/or an electric heating element.

26. The production device of claim 23, wherein the drying device comprises a heating device, and a heating capacity of the heating device is adjustable by means of a control or regulating device.

27. The production device of claim 24, further comprising a first measuring device for detecting a water content of the starting material before it is fed to the drying device and/or at the inlet of the drying device, wherein the control or regulating device is designed to set the drying capacity of the drying device depending on the water content of the starting material detected by means of the first measuring device.

28. The production device of claim 26, further comprising a first measuring device for detecting a water content of the starting material before it is fed to the drying device and/or at the inlet of the drying device, wherein the control or regulating device is designed to set the heating capacity of the heating device, depending on the water content of the starting material detected by means of the first measuring device.

29. The production device of claim 27, further comprising at least one second measuring device for detecting a water content of the starting material in the drying device and/or at the outlet of the drying device, wherein the control or regulating device is designed to set the drying capacity of the drying device depending on the water content of the starting material detected by means of the second measuring device.

30. The production device of claim 28, further comprising at least one second measuring device for detecting a water content of the starting material in the drying device and/or at the outlet of the drying device, wherein the control or regulating device is designed to set the heating capacity of the heating device depending on the water content of the starting material detected by means of the second measuring device.

31. The production device of claim 26, wherein the heating device is designed to heat up the starting material to a temperature below its melting temperature.

32. The production device of claim 22, wherein the drying device comprises a fan.

33. The production device of claim 22, wherein the drying device comprises a dry air supply and a moist air discharge.

34. The production device of claim 22, wherein the drying device comprises a substrate for moisture absorption and/or air dehumidification.

35. The production device of claim 22, wherein the feeding device comprises a first section and a second section, where undried starting material can be passed to the drying device via the first section, and dried starting material can be passed from the drying device to the application device via the second section.

36. The production device of claim 35, wherein the starting material can be taken from a supply roll via the first section.

37. The production device of claim 22, wherein the feeding device comprises a pipe element, inside which the starting material can be passed.

38. The production device of claim 22, wherein the feeding device feeds a first starting material and a second starting material to the application device, and wherein the drying device is designed for drying both the first starting material and the second starting material, and/or the feeding device is equipped with a thermometer unit for measuring a temperature of the starting material.

39. A method for layer-by-layer manufacture of a three-dimensional object, comprising:
feeding a starting material to an application device; and
melting the starting material and layer-by-layer shaping of the melted starting material into the object;
wherein the starting material is dried during or prior to being fed to the application device; and
the starting material is electrostatically discharged during the feeding; and/or
the starting material is measured to determine the cross-sectional geometries of the starting material and/or a diameter of the starting material and/or an ovality of the starting material and/or a roundness of the starting material during the feeding; and/or
the starting material is tested based on one or more of visual checking, magnetic fields, electric fields, electromagnetic fields, and ultrasound for detecting one or more of foreign bodies, impurities, filament defects, a color, and damage to a polymer structure during the feeding; and/or
a hardness of the starting material is analyzed in order to determine a hardness of the starting material during the feeding; and/or
the starting material is treated via a surface treatment unit during the feeding, by means of which the surface of the starting material is modified and/or coated.
